(19) United States
(12) Patent Application Publication
(10) Pub. No.: US 2014/0032372 A1
(43) Pub. Date: Jan. 30, 2014

(54) TRANSACTION SYSTEM AND METHOD

(71) Applicant: The Royal Bank of Scotland plc, Edinburgh (GB)

(72) Inventors: John King, Edinburgh (GB); Alan Yuill, Edinburgh (GB)

(73) Assignee: The Royal Bank of Scotland plc, Edinburgh (GB)

(21) Appl. No.: 13/950,730

(22) Filed: Jul. 25, 2013

(30) Foreign Application Priority Data
Jul. 26, 2012 (GB) 1213356.7

(51) Int. Cl. G06Q 20/12

(52) U.S. Cl. CPC G06Q 20/12
USPC 705/26.81

(57) ABSTRACT

A method and apparatus for performing a transaction based on a payment identifier which is embedded in or on a product. In response to an order for a product, a payment identifier is generated and associated with a monetary amount which is ring-fenced in an account. The payment identifier is embedded in or on the ordered product and the product is sent to a recipient. On receipt of the product, the recipient uses the payment identifier to obtain the monetary amount, via an Automated Teller Machine or an electronic bank transfer to their account. Ring-fenced monetary amounts in respect of the account are managed by a payment system and an associated method.

### TECHNICAL FIELD

The disclosure relates to methods and systems for performing transactions. In particular, but not exclusively, the disclosure relates to methods and systems for performing transactions wherein a payment identifier is inserted or embedded into a product for delivery to a recipient.

### BACKGROUND

Electronic commerce (or ‘e-commerce’) has become ubiquitous as a medium through which products and services can be bought and sold over the Internet. E-commerce provides a convenient means for vendors to present their products for perusal via a Website and for customers to purchase goods via an electronic transaction.

The rapid expansion of e-commerce has driven growth in the use of electronic gift vouchers as a replacement for traditional paper gift vouchers which are typically purchased in a conventional ‘bricks and mortar’ store. Electronic gift vouchers are purchased through a vendor's e-commerce Website and e-mailed to a recipient who may subsequently redeem the electronic gift voucher through the vendor's e-commerce portal, or alternatively print the gift voucher for redemption in a conventional store associated with the vendor. Alternatively, the electronic gift voucher may be printed (either by the vendor or the purchaser) and posted to the recipient using conventional postal services.

A drawback of electronic gift vouchers is that although they have an associated monetary value, they can only be redeemed in exchange for goods and services provided by the vendor who issued the voucher, or other companies affiliated with the vendor. Thus, from the perspective of the recipient, use of gift vouchers is relatively restricted when compared to conventional payment methods such as cash or cheque. A further drawback is that in order to redeem an electronic gill voucher through the vendor's O-commerce portal, the recipient must typically register their personal details with the vendor, which is often perceived as inconvenient and time consuming.

Recently, a number of financial institutions have introduced services which enable electronic person-to-person (PTP) payments. Such payments typically require an originator of a payment to set up the payment at a financial institution of the originator, including, by identifying the intended recipient of the payment (and the means by which the financial institution can communicate with the recipient), and the financial institution to communicate information to the pre-identified recipient, in order that the recipient can obtain the associated funds. In this context, the originator and recipient are typically a person, a company or a legal entity which holds an account with a financial institutions

### SUMMARY

According to a first exemplary aspect there is provided a computerised method of performing a transaction, the method comprising: receiving order data indicating a product and a recipient to whom the indicated product is to be delivered, the product being associated with a price equal to a first monetary amount; responsive to receiving authorization data indicating that a payment equal to or greater than the first monetary amount has been authorised, sending a ring-fence request to a payment system, the ring-fence request identifying a second monetary amount which is less than or equal to the first monetary amount, and an account from which the second monetary amount is to be ring-fenced; receiving a payment identifier associated with a monetary amount equal to the second monetary amount which has been ring-fenced, by the payment system in response to receipt of the ring-fence request; and embedding the payment identifier in or on the product indicated by the customer order for delivery to the recipient.

According to an embodiment, the method comprises, responsive to receipt of a payment request comprising the payment identifier, effecting payment of the ring-fenced monetary amount associated, with the payment identifier.

According to an embodiment, the payment request comprises account data identifying a recipient account and payment of the ring-fenced monetary amount is made to the identified recipient account.

According to an embodiment, the payment request identifies an Automatic Teller Machine (ATM) from which the payment request originates and effecting payment of the ring-fenced monetary amount comprises instructing the identified ATM to dispense a cash amount equal to the ring-fenced monetary amount.

According to an embodiment, the payment request identifies a personal communications device comprising an electronic wallet and effecting payment of the ring-fenced monetary amount comprises crediting the ring-fenced monetary amount to the electronic wallet.

According to an embodiment, the method comprises, responsive to receipt of a payment request comprising the payment identifier, sending an authorisation request to a vendor system prior to effecting payment of the ram-fenced monetary amount associated with the payment identifier.

According to an embodiment, the product indicated by the customer order is a physical product.

According to an embodiment, the product indicated by the customer order is an electronic product.

According to an embodiment, the payment identifier is embedded as an alphanumeric code, a barcode, a Radio Frequency identification (RFID) tag or a Near Field Communications (NFC) tag.

According to a second exemplary aspect there is provided a payment system for managing a plurality of ring-fenced monetary amounts associated with an account, the system comprising: a storage device configured to store account data associated with an account and shadow data indicating a plurality of ring-fenced monetary amounts associated with the account, a controller configured to: update said account data and said shadow data in response to receipt of a ring-fence request, the ring-fence request indicating a monetary amount to be ring-fenced; and provide status data for representing the status of said plurality ring-fenced monetary amounts in a graphical user interface in response to receipt of a status request, said status data being based at least in part on said shadow data.

According to an embodiment, the controller is further configured to: provide a payment identifier associated with the monetary amount indicated by said ring-fence request.

According to an embodiment, the controller is further configured to: update said account data and said shadow data in response to receipt of a payment request, the payment request comprising said payment identifier and data indicating to recipient account to which the ring-fenced monetary amount associated with said payment identifier is to be paid; and effect payment of the ring-fenced monetary amount associated with said payment identifier to said recipient account.

According to an embodiment, the controller is further configured to: provide a payment notification to an account holder of said account in response to effecting payment of the ring-fenced monetary amount associated with said payment identifier to said recipient account.

According to an embodiment, the controller is further configured to: update said account data and said shadow data in response to a receipt of a cancellation request, the cancellation request indicating a ring-fenced monetary amount in said plurality of ring-fenced monetary amounts to be cancelled.

According to a third exemplary aspect there is provided computer program product comprising a non-transitory computer-readable storage medium having computer readable instructions stored thereon, the computer readable instructions being executable by a computerised device to cause the computerised device to perform a method of performing a transaction, the method comprising: receiving order data indicating a product and a recipient to whom the indicated product is to be delivered, the product being associated with a price equal to a first monetary amount; responsive to receiving authorisation data indicating that a payment equal to or greater than the first monetary amount has been authorised, sending a ring-fence request to a payment system, the ring-fence request identifying a second monetary amount which is less than or equal to the first monetary amount, and an account from which the second monetary amount is to be ring-fenced; receiving a payment identifier associated with a monetary amount equal to the second monetary amount which has been ring-fenced by the payment system in response to receipt of the ring-fence request; and embedding the payment identifier in or on the product indicated by the customer order for delivery to the recipient.

According to an embodiment, the method comprises, responsive to receipt of a payment request comprising the payment identifier, effecting payment of the ring-fenced monetary amount associated with the payment identifier.

According to an embodiment, the payment request comprises account data identifying a recipient account and payment of the ring-fenced monetary amount is made to the identified recipient account.

According to an embodiment, the payment request identifies an Automatic Teller Machine (ATM) from which the payment request originates and effecting payment of the ring-fenced monetary amount comprises instructing the identified ATM to dispense a cash amount equal to the ring-fenced monetary amount.

According to an embodiment, the payment request identifies as personal communications device comprising an electronic wallet and effecting payment of the ring-fenced monetary amount comprises crediting the ring-fenced monetary amount to the electronic wallet.

According to an embodiment, the method comprises, responsive to receipt of a payment request comprising the payment identifier, sending an authorisation request to a vendor system prior to effecting payment of the ring-fenced monetary amount associated with the payment identifier.

Other aspects and embodiments will become apparent from the following description, claims and the accompanying drawings.

### BRIEF DESCRIPTION OF THE DRAWINGS

Various features and advantages of the disclosure will become apparent from the following description of embodiments of the disclosure, given by way of example only, which is made with reference to the accompanying drawings, of which:

FIG. 1 is a block diagram of a transaction system capable of effecting transactions according to an embodiment.

FIG. 2 is a block diagram of a payment system for use in a method of performing transactions according to an embodiment.

FIG. 3 is a block diagram of a vendor system for use in a method of performing transactions according to an embodiment.

FIG. 4 is a schematic drawing of a graphical user interface according to an embodiment.

FIG. 5 is a schematic drawing of a graphical user interface according to a further embodiment.

FIG. 6 is a flow diagram of a process of initiating a transaction according to an embodiment.

FIGS. 7A & 7B are flow diagrams of a process of setting up a transaction according to an embodiment.

FIG. 8 is a flow diagram of a process of completing a transaction according to an embodiment.

FIG. 9 is a flow diagram of a procedure for withdrawing cash from an ATM according to an embodiment.

FIG. 10 is a flow diagram of a procedure for transferring funds into a recipient account according to an embodiment.

FIG. 11 is a flow diagram of a procedure for reversing ring-fencing of funds according to an embodiment.

FIG. 12 is a schematic diagram of a graphical user interface for managing a plurality of transactions according to an embodiment.

FIG. 13 is a schematic diagram of a personal communications device in accordance with an embodiment.

### DETAILED DESCRIPTION

Various embodiments of the present disclosure will now be described in more detail with reference to the accompanying drawings. It will be appreciated that the disclosure is not limited in its application to the details of the methods and the arrangement of components as set forth in the following description or illustrated in the drawings. It will be apparent to a person skilled in the art that additional embodiments of the present disclosure not detailed in the description are possible and will fall within the scope of the claims. Accordingly, the following description should not be interpreted as limiting in any way, and the scope of protection is defined solely by the claims appended hereto.

### Overview

Exemplary embodiments described herein provide a means for performing an electronic transfer of funds from a first party (an ‘originator’) to a second party (a ‘recipient’). Such payments are conveniently termed person-to-person (PTP) payments; however it will be appreciated that PTP payments may involve one or more intermediate entities or payments in order to effect the transfer of funds from the originator to the recipient. The steps involved in performing payments according to the following embodiments can generally be characterised as a three stage process: a first stage in which a PTP payment is set up in response to a request from an originator (the ‘initiation stage’); a second stage in which a payment identifier associated with the PTP payment is delivered to a recipient (the delivery stage); and a third stage in which the recipient uses the payment identifier to receive the associated payment (the ‘collection stage’).

According to the following embodiments, delivery of the payment identifier (i.e., the delivery stage) is performed as part of delivery of a product to the recipient, wherein the product provides the transport medium through which the payment identifier is communicated. In some embodiments, the product may take the form of a greeting card or any physical item which can ‘carry’ as payment identifier. Alternatively, the product may be electronic, such as an electronic greeting card or electronic gift voucher which is delivered by e-mail, or a Short Message Service (SMS) message, for example.

Initiation of a payment is performed via a vendor portal which provides means for an originator to specify a recipient and select a transport medium through which the payment identifier is to be communicated to the recipient. For example, the vendor portal may provide means for the originator to select or customise a design of for a greetings card into which the payment identifier is to be embedded. Typically, the vendor portal will require the originator to select or specify a monetary amount to be delivered to the recipient and require the originator to make a payment equal to or greater than that monetary mount. In some embodiments, the payment made by the originator will cover the monetary amount to be associated with the payment identifier and the cost of the product into which the payment identifier is to be inserted or embedded. Further, in some embodiments, the vendor may require that the payment includes an additional fee associated with setting up the payment and generating the payment identifier.

Once the payment has been initiated by the originator and the product has been delivered to the recipient, the recipient uses the embedded payment identifier to collect the monetary amount associated with the payment using one of a number of available means, including electronic transfer of fluids or withdrawal from an automated teller machine (ATM).

A particular feature of the following embodiments is that an originator of a payment is not required to identify the bank of the recipient of the payment, for example, in advance of a payment being performed, or even at all. Moreover, a payment to a recipient can be facilitated (at least according to ‘ATM examples’ below) without the recipient having a bank account. In this context, according to certain embodiments, a recipient can be considered to be anonymous, insofar as the originator does not need to have any information about the recipient or his or her bank in order to facilitate a payment.

### Transaction System

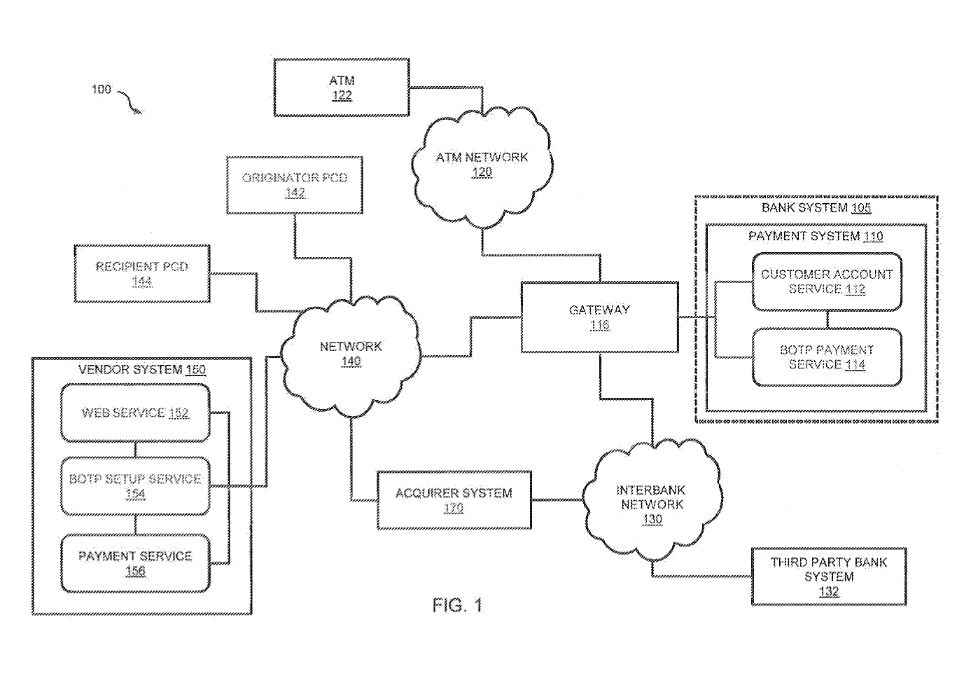

A transaction system 100 according to a first exemplary embodiment is shown in FIG. 1. The transaction system comprises a bank system 105 which in turn includes a payment system 110. The payment system 110 comprises a customer account service 112 and a blind one-time-passcode (BOTP) payment service 114. The customer account service 112 manages a plurality of customer accounts (e.g. bank accounts) which are held by a financial institution (not shown). The BOTP payment service 114 provides BOTPs in response to ring-fence requests from sources external to the bank system 105. The BOTP provided by the BOTP payment service 114 is said herein to be ‘blind’ inasmuch as, in some embodiments, payments which are set up in and facilitated by the payment system 110 are done so without knowledge of the intended recipients bank account details, contact details, or any other information identifying the recipient or a means for contacting the recipient. Thus, in this manner the payment service provides a mechanism for providing PTP payments that are closely analogous to cash transactions, where cash can of course be withdrawn from a bank and banded to anyone without informing the bank of the intended recipient.

Communications between the payment system 110 and external entities are routed through a gateway 116 which provides connectivity to a communications network 140 such as the Internet. It will be understood that communications network 140 may encompass a plurality of interconnected networks employing a range of protocols, and that in this context communications network 140 may be considered to be a network of networks. For example, communications network 140 may include a broad array of wired, wireless, cellular, and optical networking technologies which together provide for the exchange of data between the various entities connected to the network 140.

As shown in FIG. 1, access to the payment system 110 can also be provided to a plurality of ATMs 122 via an ATM network 120, which is connected to the gateway 116. In addition, a third party bank system 132 (or systems) can also connect to the payment system 110, or vice versa, via an interbank network 130 and the gateway 116. Such third party hank systems may be configured in a similar manner to the bank system 105 and thus comprise further respective payment systems of their own. Moreover, access to the payment system 110 can also be provided to one or more personal communication devices (PCD) 142 & 144, which are connected to the gateway 116 either directly or via the communications network 140. In the embodiment shown in FIG. 1, PCD 142 is associated with an originator, and PCD 144 is associated with a recipient. The gateway 116 may, of course, provides various other connections into the payment system 110, for example, for point of sale (POS) payment systems located in merchant premises (not shown).

The transaction system 100 further comprises a vendor system 150 which provides e-commerce services to customers via the network 140. The vendor system comprises a Web service 152 which provides a vendor portal, through which customers may peruse and purchase goods and services provided by the vendor or affiliated third parties. The vendor system 150 also comprises a BOTP setup service 154 which is configured to communicate with the payment system 110 via the network 140 and gateway 116 to set up one or more BOTP payments to be associated with products purchased via the Web service 152. Further, a payment service 156 is provided to process payments received from customers (e.g. payment made by debit or credit card) and in order to process such payments, the payment service 156 is configured to communicate with art acquirer system 170 which in turn communicates with, a other financial institutions in the transaction to manage the processing, clearing and settlement of the transaction (as is known in the art).

As mentioned above, PCDs 142 & 144 are associated with an originator and a recipient respectively. In practice, at least the originator PCD would typically have loaded onto it a browser application or shopping application allowing the originator to connect to the vendor portal provided by the Web service 152 to thereby enable perusal and purchase of products provided by the vendor or companies affiliated therewith. Typically, the browser application or shopping application will comprise a secure component which enables the originator to submit and transmit payment card details securely over the communications network 140 using a protocol such as the Hypertext Transfer Protocol Secure (HTTPS).

The BOTP payment setup service 154 is able to communicate with the payment system 110 via the communications network 140 and gateway 116 to send ring-fence requests the BOTP payment service 114. In response to receipt of such a request, the BOTP payment service 114 is configured to ring-fence an appropriate monetary amount (in this case from an account associated with the vendor), details of which are provided below. Once ring-fencing has been completed by the BOTP payment service 114, a payment identifier is returned to the BOTP setup service 154 for embedding in the product selected by the originator and the product is subsequently delivered to the recipient. Upon receipt of the product, the recipient uses the embedded payment identifier to collect the associated payment using the methods and systems described below.

### Payment System

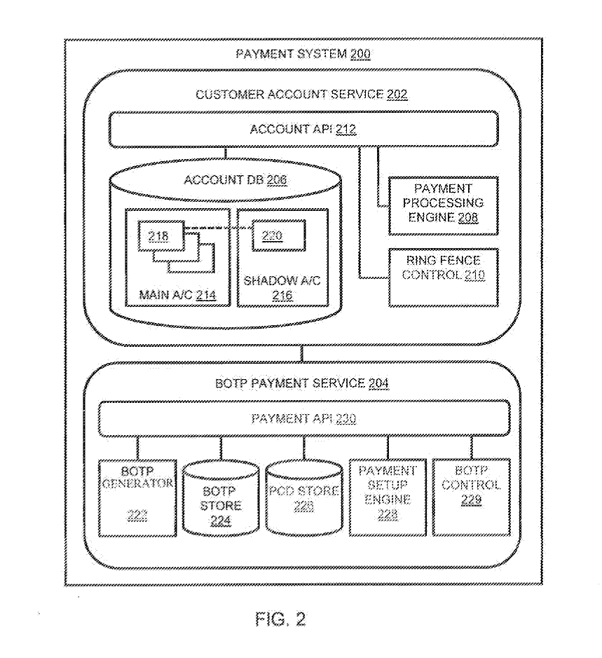

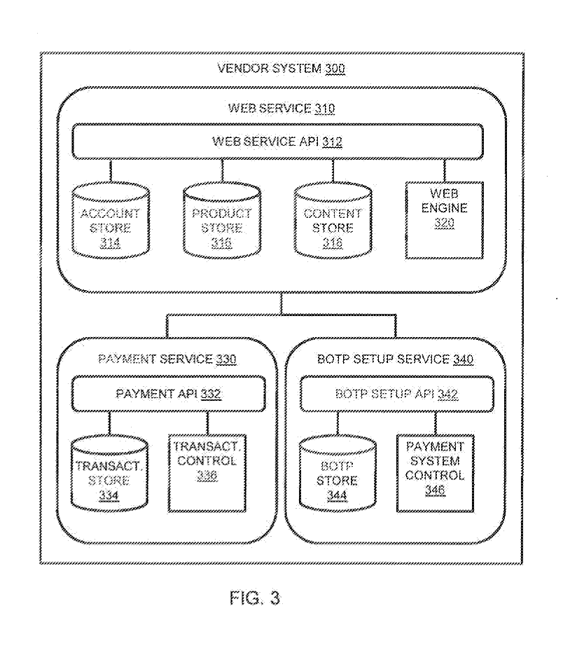

FIG. 2 shows an embodiment of a payment system 200 comprising a customer account service 202 and a BOTP payment service 204. The customer account service 202 generally is responsible for managing customer accounts, including making payments into accounts, payments out of accounts, account transfers, servicing balance enquiries, and the like. The BOTP payment service 204 generally is responsible for setting up and managing payment requests, as will be described. The customer account service 202 and the BOTP payment service 204 are in communication with one another.

The customer account service 202 includes a customer account database 206, payment processing engine 208 and a ring-fence control 210. All interactions with the customer account database 206, including by the payment processing engine 208, the ring-fence control 210, any element of the BOTP payment service 204 and any external requests (e.g. from an ATM) are via an account application programming interface (API) 212. The customer account database 206 holds account data associated with a plurality of main customer accounts 214 (including the vendor account), of which only three are shown, and shadow data associated with a plurality of respective shadow customer accounts 216. A shadow customer account 220, as will be described, exists whenever a customer account 218 is subject to ring-fencing of one or monetary amounts for the purposes of one or more respective BOTP payments. A shadow customer account 220 can also be thought of as a virtual account, which is associated with a maw account, and which may be created on demand (and deleted after use) or exist permanently with the respective main account. In alternative embodiments, ring-fencing can be managed by an appropriate process within a customer account, without the need to create or manage a shadow customer account 220 as such. However, for ease of understanding herein, an embodiment employing shadow accounts will be described.

The BOTP payment service 204 comprises a BOTP generator 222 a BOTP store 224, a PCD store 226, a payment setup engine 228 (PSE) and a BOTP control 229. All interactions with the BOTP store 224 and the PCD store 226, including by the BOTP generator 222, the payment setup engine 228 and any element of the customer account service 202, according to the present exemplary embodiment, are via a payment API 230.

### Vendor System

FIG. 3 shows an embodiment of a vendor system 300 including a Web service 310, a payment service 330 and a BOTP setup service 340. The Web service 310 is generally responsible for providing the vendor's e-commerce portal and comprises a Web service API 312 which provides an interface to the various components which together provide the portal functionality. In the embodiment shown in FIG. 3, the Web service API 312, interfaces with an account store 314, a product store 316, a content store 318 and as Web engine 320. The account store 314 stores information relating to user accounts (e.g. address details, passwords, payment card details) of customers who have previously registered with the vendor system 300. The product store 316 stores information about products provided by the vendor (e.g. photographs, descriptions and prices). The content store 318 stores the content underlying the Website (e.g. images, code and scripts). The Web engine 320 is configured to process requests received via the communications network 140 and access the various stores 314, 316 & 318 to generate pages of the portal.

Card payments to the vendor system 300 are processed by a payment API 332 which interfaces with a transaction store 334 and a transaction controller 336. The transaction controller 336 is configured to handle interactions with the acquirer system 170 via the communications network 140 to obtain authorisation of card payments made by customers. Details of completed payments (and optionally refused payments) are stored in the transaction store 334.

Requests from the vendor system 300 to the payment system 110 for payment identifiers are handled by the BOTP setup API 342 which interfaces with a BOTP store 344 and a payment system controller 346. The payment system controller 346 is configured to handle interactions with the payment system 110 via the communication network 140 and the gateway 116 in order to request ring-fencing and receive payment identifiers. Optionally, payment system controller 346 can store received payment identifiers and information relating to the associated dug-fenced amounts and products in the BOTP store 344. For example, the BOTP store 344 may store data providing referencing between payment identifiers and transactions stored in the transaction store 334.

### Initiating a Payment

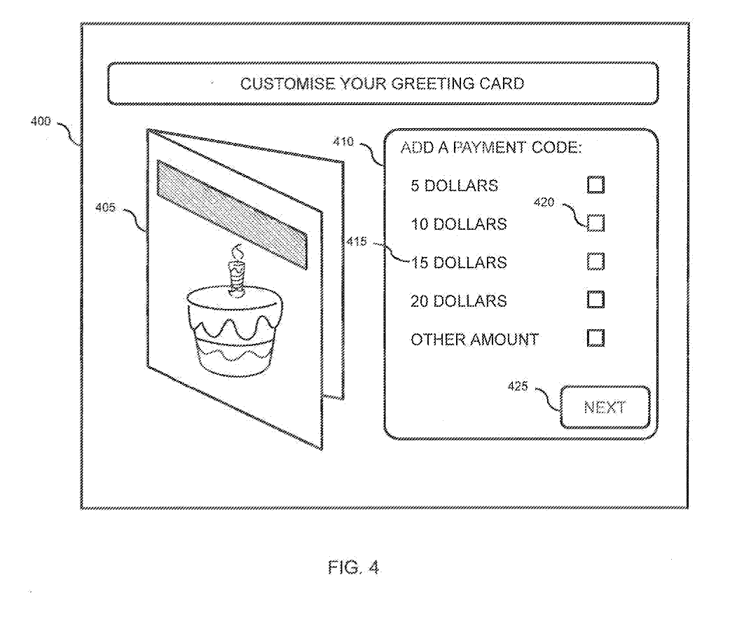

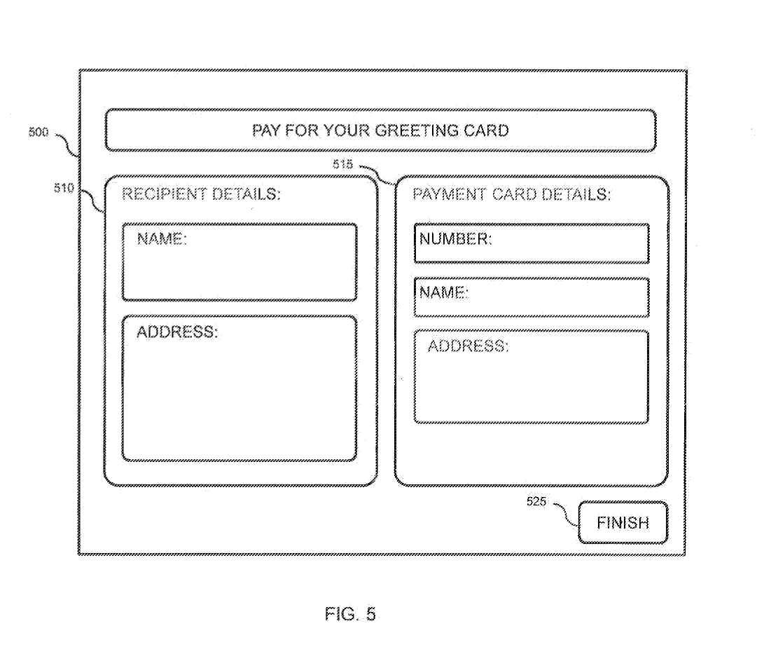

FIG. 4 shows a Web page 400 of an embodiment of the vendor Web portal provided by the vendor system 150. The page shown in FIG. 4 enables the originator to set up a transaction using a greeting card 405 as the ‘transport medium’ by which a payment identifier is communicated to the recipient. In the illustrated embodiment, the page includes a panel 410 for adding a payment code to the greeting card 405. The originator can indicate the desired payment mount 415 to be associated with the payment code by placing a tick in the relevant box 420 and clicking the ‘next’ button 425. Upon clicking the ‘next’ button 425, the originator is navigated to a payment page 500 as shown in FIG. 5. The payment page 500 includes a panel 510 for inputting the intended recipient's contact details (e.g. name, address, e-mail address) and a further panel 515 for providing the originator's payment card details (e.g. card number, name on card, expiry date and billing address). Once the details have been completed, the originator clicks the ‘finish’ button 525 which causes the vendor system 150 to obtain payment, request a payment identifier and dispatch the greetings card, as will be described below.

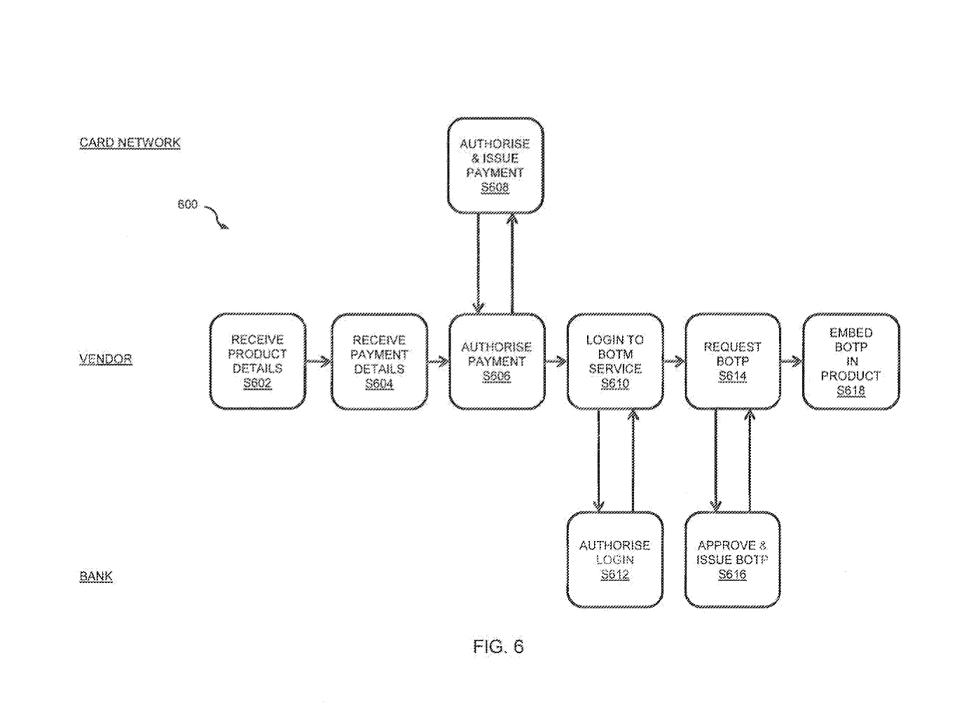

FIG. 6 shows an embodiment of an exemplary payment process 600. In the following description, numerals within square brackets represent process steps corresponding to the process steps that are as illustrated in the accompanying flow diagrams. In a first step, the vendor system 150 receives order data from the originator PCD 142 via the vendor portal [S602]. The order data typically indicates a product and a recipient to whom the indicated product is intended for delivery. In the next step [S604], the vendor system 150 receives data indicating the payment method [S604] which is typically a card payment, such as debit or credit card (collectively termed a ‘payment card’). Typically, the originator's payment card details are sent securely using HTTPS or any other suitable protocol. Upon receipt of the payment card details, the vendor system 150 communicates with the acquirer system 170 to request authorisation of the card payment using conventional methods [S606]. The acquirer system 170 interacts with other entities party to the transaction via the interbank network 130 to authorise and effect the card payment [S608]. Upon approval of the card payment, the vendor system 150 communicates with the payment system 110 via the gateway 116 and accesses the BOTP payment service 114 by providing private login information [S610], for example a user name and a password (though, obviously, other known and appropriate techniques may be employed for gaining access to the payment service 114), which is authorised by the BOTP payment service 114 [S612].

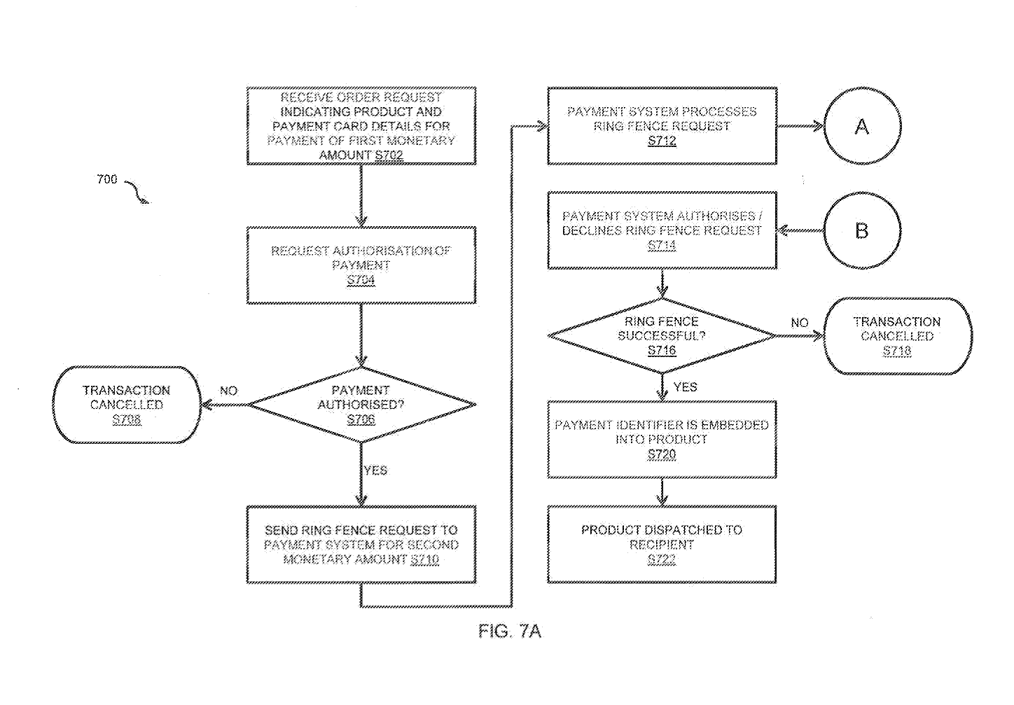

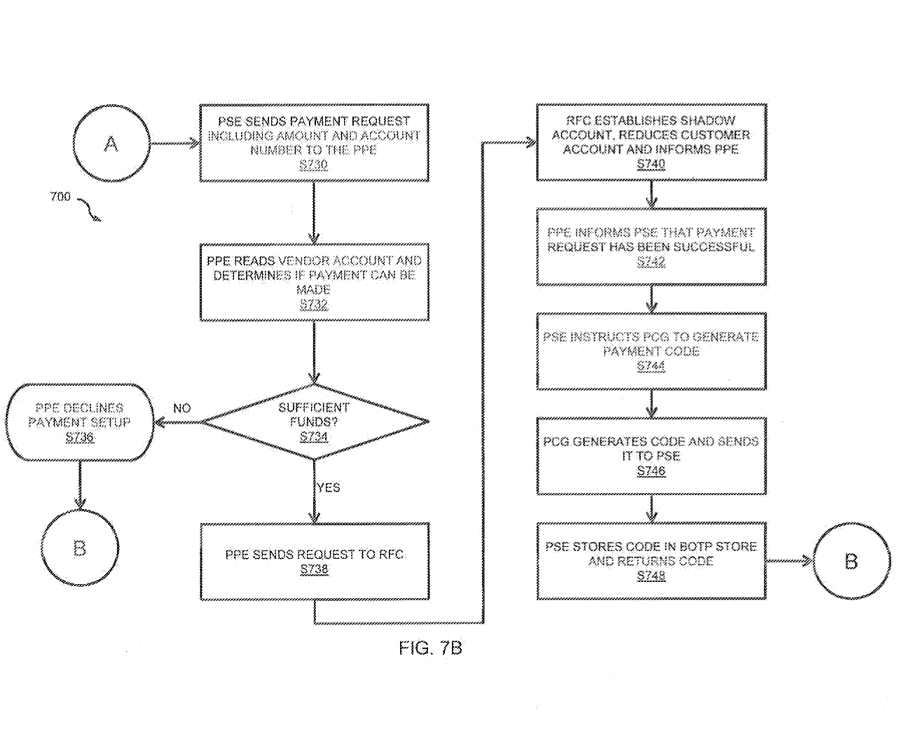

Having logged in, the vendor system 150 sends a ring-fence request [S614], specifying an account 218 from which the funds should be taken and a monetary amount to be ring-fenced. In other examples, the vendor system 150 may be automatically associated by the bank with a particular account, in which case specifying the account may not be required. In response (and subject to successful completion of certain steps described below with reference to the flow diagram in FIGS. 7A & 7B), the BOTP payment service 114 issues a payment identifier [S616], which is received by the vendor system 150 and embedded into the product to be delivered to the recipient [S618].

### Setting Up a Transaction

According to a method 700 shown in the flow diagram in FIG. 7A, the first step in setting up or initiating it transaction is the receipt of an order request indicating a product, a monetary amount to be associated with a payment identifier to be sent with the product, and details of a payment card to be used [S702]. Next, the payment service 156 sends an authorisation request to the acquirer system 170 which interacts with other entities involved in the payment to either authorise or decline the payment [S706]. If the payment is declined the transaction is ended and this is reported to the originator [S708]. If the transaction is approved, the BOTP set up service 154 sends a ring-fence request to the payment system 110 for ring-fencing of a monetary amount equal to that specified by the originator [S710]. The payment system 110 processes the ring-fence request (as explained below with reference to FIG. 7B) [S712] and informs the vendor system 150 whether the request has been authorised or declined. If the ring-fence request has been declined, the transaction is ended [S718]. When a ring-fence request has been authorised, the payment system 110 provides a payment identifier (as described below with reference to FIG. 7B) which the vendor system 150 embeds into the product [S720] for subsequent dispatch to the recipient [S722].

A process for issuing a payment identifier in response to a ring-fence request from the vendor system 150 is now described with reference to FIG. 7B. Upon receipt of a ring-fence request, the payment setup engine 228 sends a payment request, including a payment amount and the vendor account number, to the payment processing engine 208 [S730]. The payment processing engine 208 accesses the specified vendor account 218 to determine whether the account can facilitate the requested payment [S732]; for example, in terms of having sufficient funds (or sufficient credit). If the payment processing engine 208 determines [S734] that there are insufficient funds (or there is insufficient credit), a ‘request rejected’ message is returned to the payment setup engine 228 [S736]. If the payment processing engine 208 determines [S734] that that there are sufficient funds or there is sufficient credit), the payment processing engine 208 sends a request to the ring-fence control 210 to ring-fence the requested payment amount [S738].

In some embodiments, the customer account 218 represents a line of credit provided by the bank associated with the bank system 105 to the vendor associated with the vendor system 150. In such embodiments, the bank provides the ring-fencing of monetary on the basis of a trust agreement between the bank and the vendor. Such an arrangement is beneficial to the vendor when payment from a customer is made by card because it typically takes 2-3 working days before the payment is actually received by the vendor. Typically, the trust agreement between the bank and the vendor will set a credit limit of the customer account 218 and set out the terms for reconciliation of the account.

According to the present example, the ring-fence control 210 establishes a shadow customer account 220 in the customer account database 206, reduces the balance in the customer account 218 by the amount of the requested payment and informs the payment processing engine 208 that ring fencing has been completed [S740]. The shadow customer account 220 contains the amount of the requested payment.

Henceforth, any operation performed on the customer account 218 does so based on the reduced balance in the customer account 218, unless the requested payment is, for any reason, not completed. In the case of a payment that is not completed, the amount in the shadow customer account 220 is credited back into the customer account 218, as will be described below.

The payment processing engine 208 signals to the payment setup engine 228 that the payment request has been successful [S744]. In response, the payment setup engine 228 instructs the BOTP generator 222 to generate a unique payment identifier [S744]. The BOTP generator 222 returns the code to the payment setup engine 228 [S746] and the payment setup engine 228 stores the code in the BOTP store 224 and returns the payment identifier to the vendor system 150 on behalf of the BOTP payment service 204 [S748].

### Collecting a Payment

According to embodiments there are a number of potential ways in which the recipient may collect or conclude a payment. At the point of receiving the product comprising the payment identifier, the recipient has not actually received the funds. Instead, the recipient has received the means (i.e. payment identifier) by which funds can be recovered, subject to completion of additional process steps, optionally, within a certain specified period of time.

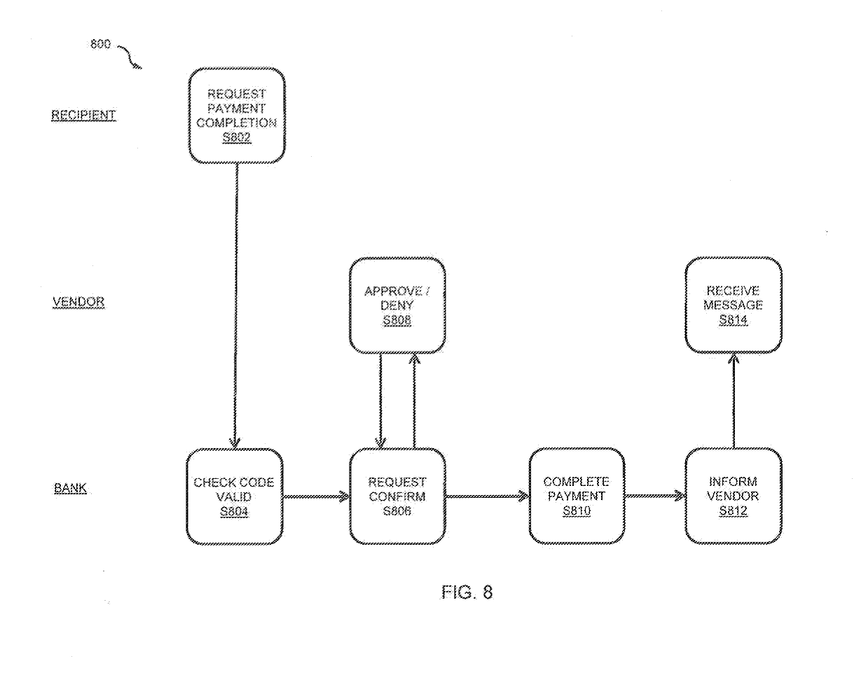

An exemplary process 800 for completing payment will now be described with reference to the flow diagram in FIG. 8. In a first step [S802], the recipient requests payment completion (for example, by bank account transfer or by ATM cash withdrawal) by causing the payment identifier to be communicated to the customer account service 112. The customer account service 112 checks that the payment identifier is valid [S804] and, optionally, communicates a confirmation request message, for example, securely to the vendor system 150 [S806] to inform the vendor that a collection is being made. In response to the optional confirmation request message, the vendor has the option to approve or deny the payment [S808]; and even contact the recipient to ensure that it is they who are attempting to complete the payment transaction. In response to approval by the vendor system 150, the customer account service 112 completes the payment [S810], for example by causing a respective ATM to deliver an associated amount of cash or transfer of fluids from the client account (although the funds have already been ring-fenced and so the vendor's account balance would not change) to another account specified by the recipient, as will be described. If a confirmation request procedure is not required, steps S806 and S808 are not performed. However, optionally again, the customer account service 112 sends a message to the vendor system 150 [S812] indicating that the payment has been completed, which message is received by the vendor system 150 [S814].

As has already been indicated, according to certain embodiments, completion of the process can be performed by the recipient using the payment identifier to withdraw cash from an ATM. According to certain other embodiments, completion of the process can be performed by the recipient using the payment identifier to transfer funds from the vendor's account to an account of the recipient. An example of each kind of embodiment for completing the process will now be described.

### ATM Embodiments

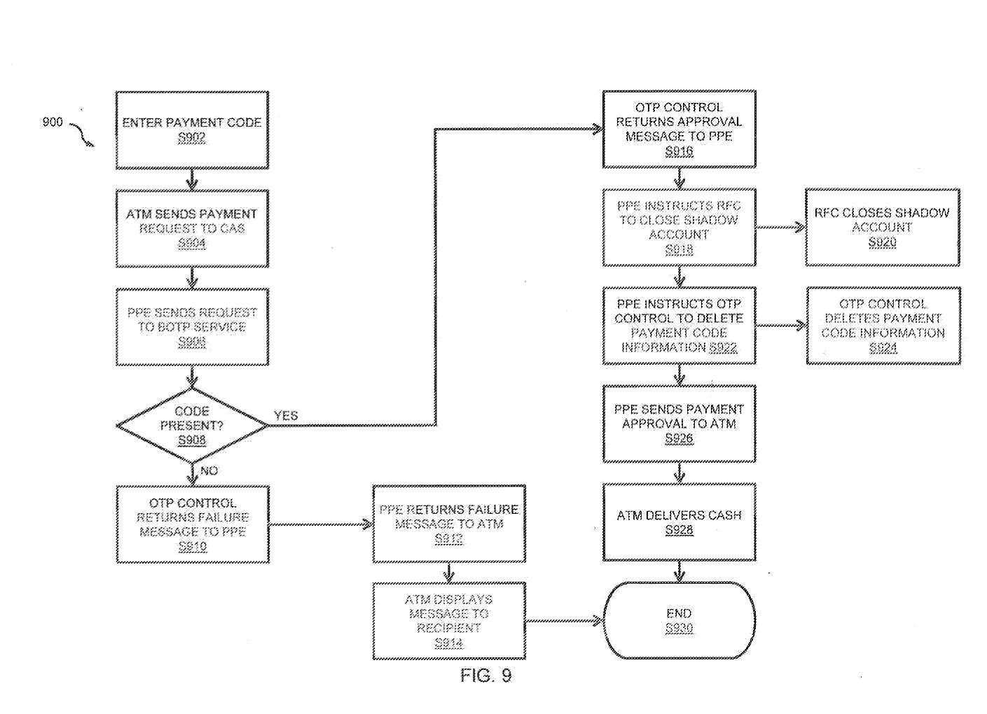

According to one embodiment, the recipient can withdraw cash in the amount of the received payment at an ATM, according to the process 900 illustrated in FIG. 9. In a first step, the recipient approaches an ATM 122 in order to withdraw funds, selects a cordless payment option via the ATM interface and enters the payment identifier when prompted to do so using the ATM keypad [S902]. In some embodiments, for added security, the recipient may also be required to enter the payment amount, which he would have learned directly from the vendor at the point of receiving the product.

In alternative embodiments the ATM 122 may be arranged to interact directly with the recipient's PCD 144, for example via NFC, imaging of the PCD screen displaying the payment code, or in any other appropriate way. For the present example, however, the recipient manually enters the payment identifier into the ATM 122, it is known that ATMs can be arranged to permit cash withdrawals without requiring an ATM card (see for example US published patent application no. US 2010-0145852 A1, the contents of which are incorporated herein in their entirety), and that facility is employed according to an exemplary process as follows.

The ATM 122 sends a respective endless payment request (including the code and optionally the payment amount), via the ATM network 120 and gateway 116, to the customer account service 112 [S904]. The payment processing engine 208 sends the cardless payment request to the BOTP payment service 204 [S906], in which the BOTP control 229 compares the payment identifier and optionally the amount information to information stored in the BOTP store 224 [S908] to determine if the payment identifier is present and hence valid. If the information in the cardless payment request cannot be matched to information in the BOTP store 224, the BOTP control 279 returns a failure message to the payment processing engine 208 [S910]; and the payment processing engine 208 returns a respective failure message to the ATM 122 [S912], which in turn displays an appropriate message to the recipient [S914]. If, however, the information in the cardless payment request is matched to information in the BOTP store 224 (the optional step of obtaining confirmation from the vendor may be performed at this point but will not be described again, for simplicity of description only), the BOTP control 229 sends an approval message to the payment processing engine 208 [S916]. In response, the payment processing engine 208 optionally instructs the ring-fence control 210 to close the shadow customer account 220 if no other ring-fenced amounts remain outstanding [S918] (which the ring-fence control 210 does [S920]), instructs the BOTP control 229 to mark as paid the associated payment identifier information in the BOTP store 224 [S922] (which the BOTP control 229 does [S924]) and then sends a payment approval message to the ATM 122 [S926]. On receiving the payment approval message, the ATM 122 delivers the respective amount of cash to the recipient [S928]. The ATM 122 returns a payment completed notification to the payment processing engine 208. At that point, the process has been completed [S930], although, as described above (not shown in FIG. 9), a message may be communicated to the vendor system 150 indicating to the vendor that the payment has been completed.

It will be appreciated that, according to the foregoing example, the recipient has been able to withdraw the specified amount of cash from an ATM without having to provide any identification information and without even having to have a bank account of their own. In principle, all that is required is entry of the payment identifier into an appropriately arranged ATM. Of course, in the example provided, the recipient can also be required to provide the amount of the payment, but this is merely an optional step to add an element of security (for example, to increase the difficulty a fraudster would have to successfully withdraw cash from an ATM by entering random numeric strings).

The present embodiment as described will operate, to permit cardless cash withdrawals from an ATM, if the recipient interacts with an ATM belonging to the same bank as the vendor: because only the vendor's payment system 110 has knowledge of the payment identifier. In alternative embodiments, the payment identifier includes a prefix comprising one or more numbers (for example a bank sort code, which in the UK has six numeric characters), to identify the payment system 110 that generated the payment identifier. In this way, and assuming an appropriate inter-bank process is in place, a third party ATM would be able to deliver cash by obtaining approval from the vendor's payment system 110 (and establishing a respective cross-charge between banks).

### Funds Transfer Embodiments

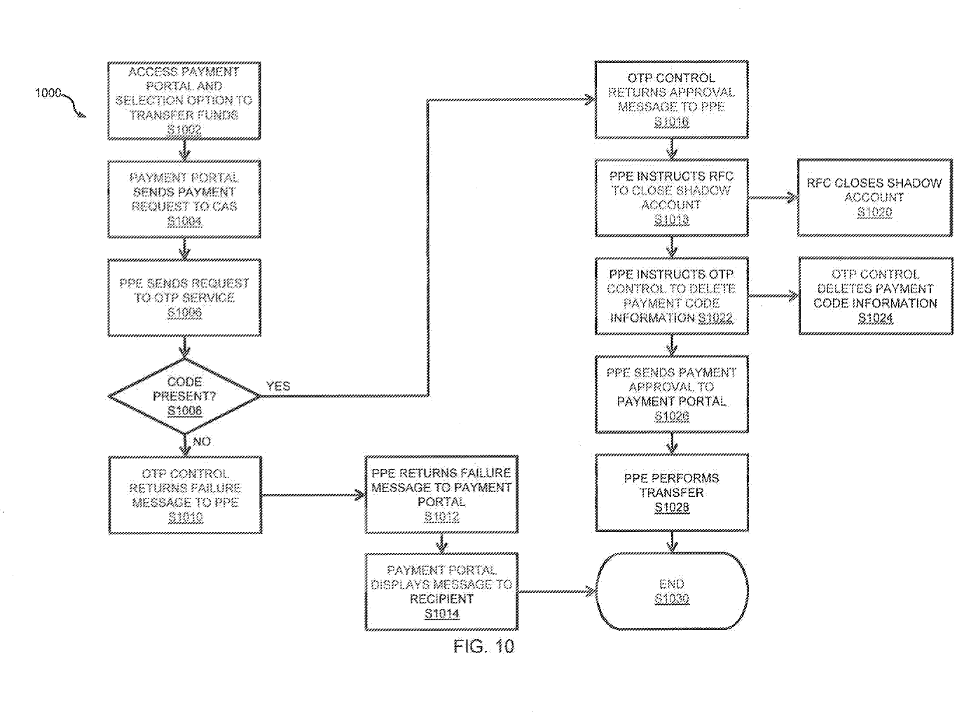

According to one embodiment, the recipient can transfer funds to a specified an account, according to the process 1000 illustrated in FIG. 10. In this embodiment, the recipient's PCD 144 would typically have loaded onto it a browser application or payment application allowing the recipient to connect to the payment system 110 to collect or complete the payment. Alternatively, the portal provided by the vendor system 150 may act as a proxy to the payment system 110, thereby allowing the recipient to collect the payment by connection to the vendor system 150 rather than the payment system directly 110.

In a first step [S1002], the recipient selects on the recipient PCD 144 an option to transfer funds, according to the payment identifier and amount information, into a bank account of the recipient. Details of the bank account of the recipient may be programmed into the recipient PCD 144, provided by the recipient or, once logged on to the payment system 110, the bank may be able to match the recipient PCD 144 with an appropriate recipient account. The recipient PCD 144 in response sends a funds transfer request (including, the payment identifier, optionally confirmation of the payment amount and, if required, a bank account identifier), via the communications network 140 and gateway 116, to the customer account service 202 [S1004]. The payment processing engine 208 sends the funds transfer request to the BOTP payment service 204 [S1006], in which the BOTP control 229 compares the payment identifier and amount information to information stored in the BOTP store 224 [S1008] to determine if the payment identifier is present and hence valid. If the information in the funds transfer request cannot be matched to information in the BOTP store 224, the BOTP control 229 returns a failure message to the payment processing engine 208 [S1010], and the payment processing engine 208 returns a respective failure message to the recipient PCD 144 [S1012], which in turn displays an appropriate message to the recipient [S1014]. If, however, the information in the funds transfer request is matched to information in the BOTP store 224 (the optional step of obtaining confirmation from the recipient may be performed at this point but will not be described again, for simplicity of description only), the BOTP control 229 sends an approval message to the payment processing engine 208 [S1016]. In response, the payment processing engine 208 instructs the ring-fence control 210 to close the shadow customer account 220 if no other ring-fenced amounts remain outstanding [S1018] (which the ring-fence control 210 does [S1020]), instructs the BOTP control 229 to delete the associated payment identifier infbrmation from the BOTP store 224 [S1022] (which the BOTP control 229 does [S1024]) and then sends a transfer approval message to the recipient PCD 144 [S1026]. In addition, the payment processing engine 208 instructs a transfer of funds to the identified bank account [S1028]. At that point, the process has been completed [S1030], although, as described above (not shown in FIG. 10), a message may be communicated to vendor system 150 indicating to the vendor that the payment has been completed.

In embodiments in which the customer account 218 of the vendor and the identified account of the recipient are maintained in the same payment system 110, such a transfer of funds from the vendor to the recipient is typically relatively straightforward. In other embodiments in which the identified account of the recipient is not maintained in the payment system 110, it may be necessary to conform to existing interbank transaction standards to perform the transfer. For example, existing interbank transaction standards may not permit payments to be ‘pulled’ (that is, requested) by a recipient's bank from the vendor's bank: instead, a payment may have to be ‘pushed’ (that is, sent) by the vendor's bank to the recipient's bank. The funds transfer process described above conducts a payment in this manner, with the vendor's bank pushing funds, via the gateway 116 and interbank network 130, to the third party hank system 132 which maintains the identified account. In order to facilitate the funds transfer instruction, the vendor's payment system 110 is arranged to interact with the recipient, who does not have a customer account in the payment system 110. As will be appreciated, it is not usual for a bank (and its systems) to interact with people who are not customers, having pre-established banking relationships, customer accounts and personal login information. However, in the same manner in which a non-customer is able withdraw cash from an ATM without haying an account and ATM card) with the respective bank, embodiments herein facilitate communications between as payment system 110 and parties who are not customers; the only requirement being that a party is a recipient who has a valid payment identifier.

Of course, in order for a non-customer recipient to interact with the payment system 110, the recipient needs to know how to control their recipient PCD 144 to contact the appropriate payment system 110 which holds the shadow account 220 associated with the payment identifier. There are a number of ways of achieving this. For example, the funds transfer process may simply be initiated, if the recipient directs its recipient PCD 144 to a home web page of the respective bank and selects a ‘Non-customer funds transfer service’ (that is provided according to the present embodiment), which provides the recipient PCD 144 with a means for presenting, a payer code, an amount and appropriate bank account identifier. Alternatively, as mentioned above, the recipient my direct its recipient PCD 144 to the vendor's portal and select a ‘Funds transfer service’, in response to which the portal could redirect the PCD to the payment system 110.

Where the vendor system 150 acts as a proxy, the recipient may request that the payment be credited to their vendor account. In such embodiments, the vendor system 150 would utilise the payment identifier to receive the payment and would credit an appropriate amount to the recipient's account with the vendor for future use by the recipient. Such embodiments are attractive from a vendor perspective because they ensure that the ring-fenced monetary amount is spent with the vendor.

According to further embodiments of the disclosure, additional information is provided by the vendor system 150 to the recipient during the PTP payment process. More particularly, at step [S722] of the PTP payment process, the additional information sent to the recipient with the product comprises a network address (or network service address), for example a URL, that can subsequently be used by the recipient PCD 144 to contact the payment system 110, in the event that a funds transfer procedure is required. In practice, the address could direct the recipient PCD 144 to the gateway 116, which could then direct the recipient PCD 144 to the customer account service 112. In some embodiments, the payment identifier may be encoded together with the network address in barcode (e.g. in a QR code or 2-D barcode) such that the payment can be easily collected by imaging the barcode using the recipient's PCD 144.

According to alternative embodiments, the payment system 110 and third party and system 132 are arranged to facilitate ‘pulled’ payments. In such cases, a recipient should be able to communicate with his own bank to request a funds transfer based on the payment identifier, the amount and in addition, an indication of an identity of the vendor's bank. Again, an identity of the vendor bank may be provided, for example, at step [S810] of the payment process. Then, based on the identity, the third party bank system 132 can contact the payment system 110 to arrange the funds transfer.

It will be appreciated that, according to the foregoing example, the recipient has been able to arrange a transfer of funds irrespective of whether or not the recipient banks at the same bank as the vendor.

Another alternative way of managing interbank funds transfers, according to embodiments of the present disclosure, is for a third party service provider to manage the payments—in terms of issuing and redeeming payment identifiers on behalf of the banks. The third party payments provider could either be set-up by banks who want to offer the service, or it could be a service to which banks can subscribe in order to offer the service to their respective customers. Appropriate APIs would need to be established between the banks and the service provider, in order for the service provider to be able to manage payment set-up and completion.

### Ring-Fence Control

As has already been indicated, if a payment is not completed, for example within a set time period, the ring-fencing performed by the payment system 110 can be reversed. According to embodiments, a payment associated with a payment identifier has to be completed by the recipient within a period of time, for example a standard fixed period of, say, two weeks from the time when the payment is first ring-fenced by the payment system 110. Alternatively, the vendor system 150 may be adapted to communicate to the payment system 110 when the payment has been made to a recipient, and the time limit may then be set to start from that point. In any event, the vendor system 150 may be arranged to inform the recipient PCD 144 of how long the payment identifier accompanying the product is valid for.

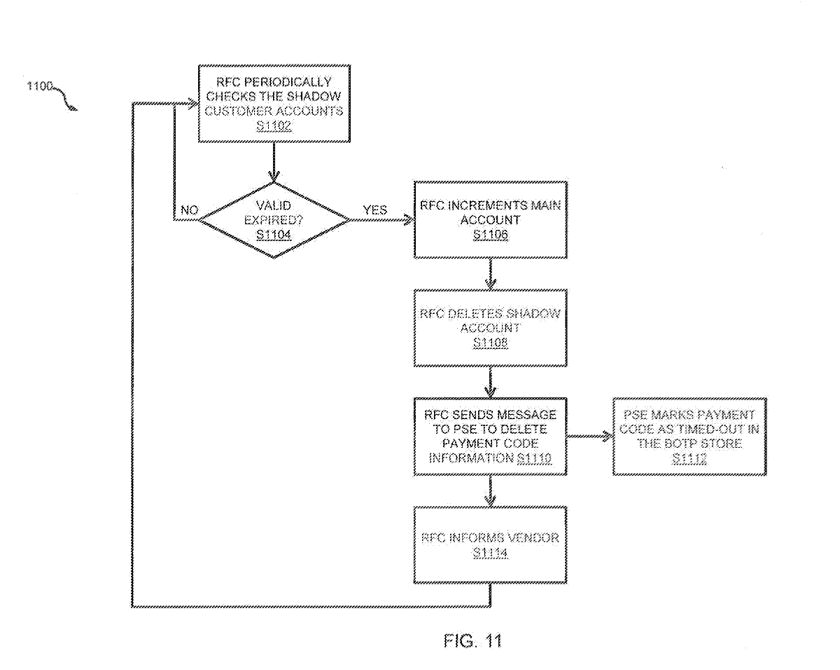

Ring-fencing reversal can be achieved according to a process 1100 shown in the flow diagram of FIG. 11. According to a first step [S1102], periodically (for example, every ten minutes), the ring-fence control 210 scans the shadow customer accounts 216 to determine if any shadow customer account 220 has passed its valid period, for example by reference to a time stamp provided to each account when it was set up by the ring-fence control 210. For any shadow customer account 220 that has expired [S1104], by having passed the valid period, the ring-fenced amount in the shadow customer account 220 is incremented into the associated main customer account 218 [S1106] and the shadow customer account 220 is deleted if no other ring-fenced amounts remain outstanding [S1108]. In effect, the ring-fencing, has been reversed and the funds are returned to the customer account 218, and the balance in the customer account 218 is adjusted to reflect the increment. In addition, the ring-fence control 210 may send a message to the payment setup engine 228 [S1110], which in turn marks the payment identifier information as timed-out in the BOTP store 224 [S1112], so that any subsequent attempt to use the payment identifier would fail. This step mar not be deemed necessary, however, according to an embodiment in which the conclusion of any payment includes a check for an associated shadow customer account 220 (which has already been deleted). Finally and optionally, the fact that the payment identifier is no longer valid author that the recipient has not used the payment identifier in time, is communicated to the customer (i.e. the vendor) [S1114]. The process then iterates to the first step [S1102]. Of course, a similar ring-fence removal process may be applied when ring-fencing is processed within a main account rather than by using shadow accounts. Additionally, or alternatively, ring-fence removal may be performed using period batch processing (e.g. every hour or other appropriate period), via notification services, or in any other appropriate way. Of course, whenever a BOTP has been used or times-out and is deactivated in an appropriate way, the code may be re-used in another transaction without causing any conflicts. Accordingly, there does not need to be an unreasonably large number of available codes, and codes can be kept commensurately short.

### Management Interface

In some embodiments the payment system 110 is configured to provide an interface which provides the vendor system 150 with means to administer or manage the ring-fenced monetary amounts associated with the vendor's account. Such an interface is desirable because, at a particular time, the vendor's account may be associated with a large number of ring-fenced payments which have not yet been collected by their intended recipients. Thus, the vendor's account will be associated with potentially hundreds or thousands of ring-fenced monetary amounts at any particular time. In order to facilitate management of the ring-fenced monetary amounts, the account API 212 is configured to provide status data which represents the status of the ring-fenced monetary amounts associated with an account (i.e. the vendor's account(s)). Typically, the status data provided by the account API 212 takes the form of HTML or similar and is used to render a Web page (i.e. a management graphical user interface or ‘GUI’) which provides the vendor with means to manage their account and the associated ring-fenced monetary amounts. In response to a request for a management GUI, the account API 212 queries the account database 206 and retrieves data relating to outstanding ring-fenced amounts in the associated shadow account 220 in order to generate the status data.

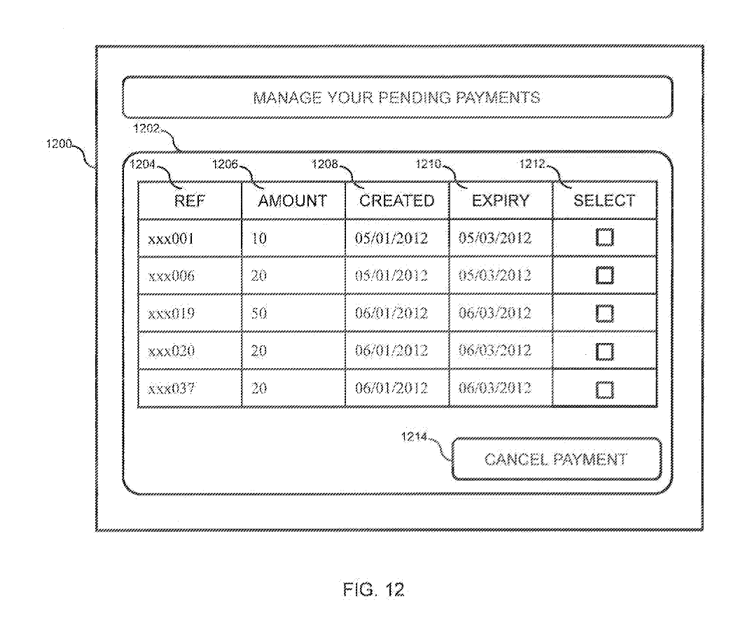

FIG. 12 shows an embodiment of the GUI 1200 provided by account API 212 as presented to the vendor as a Web page in a Web browser application. The GUI 1200 comprises a table 1202 which includes details of the outstanding ring-fenced monetary amounts in the associated shadow account. The table 1202 further includes a column for the payment identifier 204, the monetary amount 1206, the creation (i.e. ring-fence) date 1208 and the expiry date 1210 of each ring-fenced amount. Further, each ring-fenced amount listed in the table 1202 in associated with a tick box 1212 which enables the vendor to select one or more of the ring-fenced amounts for further processing. In the simplified GUI shown in FIG. 12, using the tick boxes, the vendor may select one or more ring-fenced monetary amounts to be cancelled. Once the ring-fenced amounts have been selected, the vendor can click the ‘cancel payment’ button and account API 212 instructs the ring-fence control 210 to cancel the specified ring-fenced amounts from the shadow account 220 and increment the main account 218 accordingly.

### Alternative Payment Identifiers

Thus far, payment identifiers have typically comprised alpha and/or numeric strings; with a recipient having to enter the string into an ATM or control their PCD to use the string in an account funds transfer process. In alternative embodiments, other kinds, of payment identifier are envisaged for example 2-D or 3-D barcodes (or any other graphically encoded payment identifier). Such codes can on the product are be ‘imaged’ by an ATM (or any other suitable equipment or apparatus within or outside of to bank) or the recipient's PCD smartphone), which has been enabled with, for example, a camera or scanner. In this way, the recipient would not need to enter numbers manually into an ATM (or any other suitable equipment or apparatus within or outside of a bank). Where the payment identifier is graphically encoded, the recipient PCD may be a wearable computer device (e.g. Google Glass™ provided by Google Inc. of Mountain View, Calif., USA) which is configured to automatically obtain the payment identifier, using an on-board image capture device, and to communicate the payment identify to the payment system such that the associated funds are transferred to the recipient's preferred account using the methods discussed above.

In farther embodiments, the payment identifier may be tagged to the product in the form of a radio-frequency identification (RFID) tag, a near field communication (NFC) tag, or any other suitable type of transponder (either passive or active). When such tags are utilised, the recipient's PCD would be equipped with suitable means to interrogate the transponder in order to obtain the payment identifier. Similarly, an ATM may be provided with interrogation means to obtain the payment identifier prior to completing the payment according to the embodiments described above.

### Bank System Architecture

It will be appreciated that the arrangement of the bank system 105, the payment system 110, the customer account service 102, the various APIs, the gateway 116 and all other components and functions of the overall architecture are described herein by way of example only and, as will be appreciated by the skilled person, by the very nature of computer implemented systems in general, any other system arrangements and configurations may be used instead to perform generally the same functions. The bank system 105 may, for example, comprise a mainframe computer operating the z/OS operating system and performing all of the various transactions using CICS, with appropriate databases being employed to store and manage customer accounts and the like. Suitable Web service and telephone integration elements can also be adapted and provided as required.

### Exemplary PCD

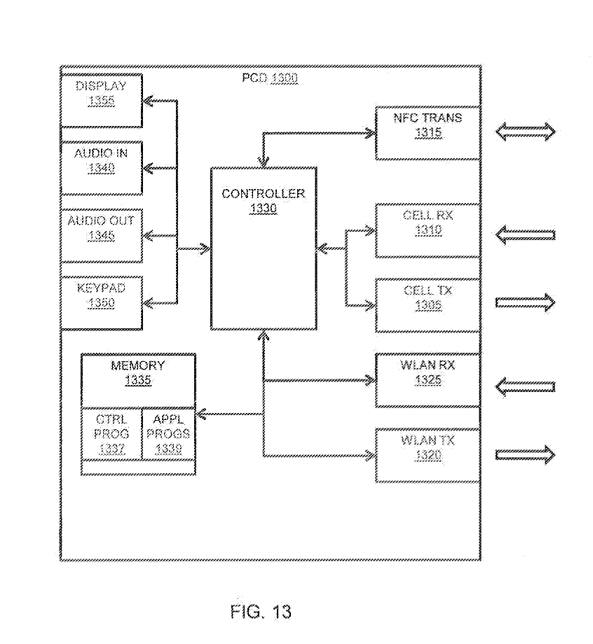

A PCD that can operate as an originator PCD 142 and/or a recipient PCD 144 is illustrated functionally in the diagram in FIG. 13. The PCD 1300 in this example is a smartphone that can perform standard cellular (e.g. GSM) communications in addition to WLAN (Wi-Fi) communications. The PCD 1300, includes a cellular transmitter 1305 and a cellular receiver 1310. In addition, or alternatively, the PCD 1300 can communicate using NFC standards using an NEC transceiver 1315 and via WLAN via a WLAN transmitter 1320 and a WLAN receiver 1325 arrangement. All such transmitter/receiver/transceiver elements are well known. The PCD 1300 further includes a controller 1330, which typically comprises an embedded control processor, and which controls the overall operation of the PCD 1300, including the operation of the various wireless/radio interfaces. The controller 1330 operates in accord with a control program 1337 and various application programs 1339 that are stored in a memory 1335, which may include nonvolatile (e.g. Flash) and volatile memory elements. The PCD 1300 also includes standard user interface elements, such as Audio In 1340, Audio Out 1345, a keypad 1350 and a display 1355: if the display is touch sensitive, the keypad may not be present.

As used hereinbefore, the term ‘account’ is intended to encompass any kind of financial account that stores monetary value or provides a credit facility, and also any other kind of value that can be added to or deducted from. For example, apart from monetary value, an account could store ‘points’ such as Airmiles™ or other kinds of accruable reward points, or the like, which can be used as a currency instead of money in certain kinds of transactions.

The above embodiments are to be understood as illustrative examples of the disclosure. Further embodiments of the disclosure are envisaged, and would, on the basis of the foregoing disclosure, be evident to the skilled person. It is to be understood that any feature described in relation to any one embodiment may be used alone, or, if the context permits, in combination with other features described, and may also be used in combination with one or more features of any other of the embodiments, or any combination of any other of the embodiments. Furthermore, equivalents and modifications not described above may also be employed without departing, from the scope of the disclosure, which is defined in the accompanying claims.

1. A computerised method of performing a transaction, the method comprising:
receiving order data indicating a product and a recipient to whom the indicated product is to be delivered, the product being associated with a price equal to a first monetary amount;
responsive to receiving authorisation data indicating, that a payment equal to or greater than the first monetary amount has been authorised, sending a ring-fence request to a payment system, the ring-fence request identifying a second monetary amount which is less than or equal to the first monetary amount, and an account from which the second monetary amount is to be ring-fenced;
receiving a payment identifier associated with a monetary amount equal to the second monetary amount which has been ring-fenced by the payment system in response to receipt of the ring-fence request; and
embedding the payment identifier in or on the product indicated by the customer order for delivery to the recipient.

2. A computerised method of performing a transaction according to claim 1, the method comprising, responsive to receipt of a payment request comprising the payment identifier, effecting payment of the ring-fenced monetary amount associated with the payment identifier.

3. A computerised method of performing a transaction according to claim 2, wherein the payment request comprises account data identifying a recipient account and payment of the ring-fenced monetary amount is made to the identified recipient account.

4. A computerised method of performing a transaction according to claim 2, wherein the payment request identifies an Automatic Teller Machine (ATM) from which the payment request originates and effecting payment of the ring-fenced monetary amount comprises instructing the identified ATM to dispense a cash amount equal to the ring-fenced monetary amount.

5. A computerised method of performing a transaction according to claim 2, wherein the payment request identities a personal communications device comprising an electronic wallet and effecting payment of the ring-fenced monetary amount comprises crediting the ring-fenced monetary amount to the electronic wallet.

6. A computerised method of performing a transaction according to claim 1, the method comprising, responsive to receipt of a payment request comprising the payment identifier, sending an authorisation request to a vendor system prior to effecting payment of the ring-fenced monetary amount associated with the payment identifier.

7. A computerised method of performing a transaction according to claim 1, wherein the product indicated by the customer order is a physical product.

8. A computerised method of performing a transaction according to claim 1, wherein the product indicated by the customer order is an electronic product.

9. A computerised method of performing a transaction according to claim 1, wherein the payment identifier is embedded as an alphanumeric code, a barcode, a Radio Frequency Identification (RFID) tag or a Near Field Communications (NFC) tag.

10. A payment system for managing a plurality of ring-fenced monetary amounts associated with an account, the system comprising:
a storage device configured to store account data associated with an account and shadow data indicating a plurality of ring-fenced monetary amounts associated with the account;
a controller configured to:
update said account data and said shadow data in response to receipt of a ring-fence request, the ring-fence request indicating a monetary amount to be ring-fenced; and
provide status data for representing the status of said plurality ring-fenced monetary amounts in a graphical user interface in response to receipt of a status request, said status data being based at least in part on said shadow data.

11. A payment system according to claim 10, wherein the controller is further configured to:
provide a payment identifier associated with the monetary amount indicated by said ring-fence request.

12. A payment system according to claim 10, wherein the controller is further configured to:
update said account data and said shadow data in response to receipt of a payment request, the payment request comprising said payment identifier and data indicating a recipient account to which the ring-fenced monetary amount associated with said payment identifier is to be paid; and
effect payment of the ring-fenced monetary amount associated with said payment identifier to said recipient account.

13. A payment system according to claim 12, wherein the controller is farther configured to:
provide a payment notification to an account holder of said account in response to effecting payment of the ring-fenced monetary amount associated with said payment identifier to said recipient account.

14. A payment system according to claim 10, wherein the controller is further configured to:
update said account data and said shadow data in response to a receipt of a cancellation request, the cancellation request indicating a ring-fenced monetary amount in said plurality of ring-fenced monetary amounts to be cancelled.

15. A computer program product comprising a non-transitory computer-readable storage medium having computer readable instructions stored thereon, the computer readable instructions being executable by a computerised device to cause the computerised device to perform a method of performing a transaction, the method comprising:
receiving order data indicating a product and a recipient to whom the indicated product is to be delivered, the product being associated with a price equal to a first monetary amount;
responsive to receiving authorisation data indicating that a payment equal to or greater than the first monetary amount has been authorised, sending to ring-fence request to a payment system, the ring-fence request identifying a second monetary amount which is less than or equal to the first monetary amount, and an account from which the second monetary amount is to be ring-fenced;
receiving a payment identifier associated with a monetary amount equal to the second monetary amount which has been ring-fenced by the payment system in response to receipt of the ring-fence request; and
embedding the payment identifier in or on the product indicated by the customer order for delivery to the recipient.

16. A computer program product according to claim 15, wherein the method comprising, responsive to receipt of a payment request comprising the payment identifier, effecting payment of the ring-fenced monetary amount associated with the payment identifier.

17. A computer program product according to claim 16, wherein the payment request comprises account data identifying a recipient account and payment of the ring-fenced monetary amount is made to the identified recipient account.

18. A computer program product according to claim 16, wherein the payment request identifies an Automatic Teller Machine (ATM) from which the payment request originates and effecting payment of the ring-fenced monetary amount comprises instructing the identified ATM to dispense a cash amount equal to the ring-fenced monetary amount.

19. A computer program product according to claim 16, wherein the payment request identifies a personal communications device comprising an electronic wallet and effecting payment of the ring-fenced monetary amount comprises crediting the ring-fenced monetary amount to the electronic wallet.

20. A computer program product according to claim 15, wherein the method comprises, responsive to receipt of a payment request comprising the payment identifier, sending an authorisation request to a vendor system prior to effecting payment of the ring-fenced monetary amount associated with the payment identifier.
